(19) United States
(12) Patent Application Publication
(10) Pub. No.: US 2002/0104749 A1
(43) Pub. Date: Aug. 8, 2002

(54) Tactile switch

(75) Inventor: Kazuki Omata, Yamanashi-ken (JP)

Correspondence Address: Ira J. Schultz, DENNISON, SCHEINER & SCHULTZ, Suite 612, 1745 Jefferson Davis Highway, Arlington, VA, 22202, US

(73) Assignee: Citizen Electronics Co., Ltd.

(21) Appl. No.: 10/054,939

(22) Filed: Jan. 25, 2002

(30) Foreign Application Priority Data
Feb. 7, 2001 (JP) 2001-031618

(51) Int. Cl. H01H 5/18

(52) U.S. Cl. 200/406

(57) ABSTRACT

An annular first fixed contact is provided on a substrate, and a second fixed contact is provided on the substrate within the first fixed contact. A spherical spring contact having legs is mounted on the first fixed contact by the legs.

### BACKGROUND OF THE INVENTION

The present invention relates to a tactile switch used in a portable telephone, portable radio receiver, camera and others.

FIG. 6 is a plan view showing a conventional tactile switch, FIG. 7 is a sectional view taken along a line VII-VII of FIG. 6, FIG. 8 is a bottom view of the tactile switch and FIG. 9 is a plan view showing a substrate 1.

The tactile switch has a side of 4 mm and a thickness of 0.5 mm. The switch has a substrate 1, a first fixed contact 5 secured to the substrate 1, a spring contact 4 mounted on the first fixed contact 5 and a flexible cover 3 made of plastic and secured to the substrate 1 through a spacer 2 so as to provide a watertight sealing.

The spring contact 4 has a semispherical shape and is surrounded by a wall of a circular hole 2a of the spacer 2. Each of four corners of the substrate has a semicircular recess. As shown in FIG. 8, four terminal electrodes 9a to 9d are secured to the underside of the substrate 1 at the four corners in order to connect the tactile switch with an instrument to be mounted therein. Each of the terminal electrodes 9a to 9d is connected to a conductive pattern on the substrate 1 through a lead provided on the semicircular recess.

As shown in FIG. 7 and 9, the first fixed contact 5 is provided on a peripheral portion of the substrate to form a circular vacancy, and connected to the terminal electrode 9a through the lead on the semicircular recess. The spring contact 4 is contacted with the first fixed contact 5 at the peripheral edge thereof.

A second fixed contact 6 is securely mounted on the underside of the substrate 1 at a central portion of the circular vacancy. The second fixed contact 6 is connected to the terminal electrode 9c by a lead provided in a through-hole 7 and a conductive pattern 8.

The spring contact 4 is depressed through the cover 3 by a push button provided in the instrument, so that a central portion of the spring contact 4 is downwardly bent. When the spring contact 4 passes a neutral point, the spring contact quickly inverts. Thus, the spring contact contacts with the second fixed contact 6, so that the first fixed contact 5 is connected to the second fixed contact 6.

Such a tactile switch must endure a large number of operations. For example, the tactile switch mounted in the portable telephone must endure over 500,000 operations. For the long life, stainless steel is used for the spring contact. However, the stiffness of the spring contact is liable to be extremely high, because the size of the spring contact is very small. As a result, the spring contact strikes hard against the second fixed contact, thereby producing harsh noises.

In addition, the through-hole 7 causes the manufacturing cost of the tactile switch to increase.

### SUMMARY OF THE INVENTION

An object of the present invention is to provide a tactile switch which is simple in construction, excellent in function, and has a long life and high reliability.

According to the present invention, there is provided a tactile switch comprising a substrate, an annular first fixed contact provided on the substrate, a second fixed contact provided on the substrate within the first fixed contact, a spherical spring contact having legs contacted with the first fixed contact.

Each of the legs contacts with the first fixed contact at a peripheral edge thereof.

An arc portion is formed between adjacent legs.

The second fixed contact is connected to a terminal electrode by a conductive pattern passing through a passage formed in the first fixed contact and a space formed under the arc portion.

These and other objects and features of the present invention will become more apparent from the following detailed description with reference to the accompanying drawings.

### BRIEF DESCRIPTION OF DRAWINGS

FIG. 1 is a plan view of a tactile switch of the present invention;

FIG. 2 is a sectional view taken along a line II-II of FIG. 1;

FIG. 3 is a sectional view taken along a line III-III of FIG. 1;

FIG. 4 is a bottom view of the tactile switch;

FIG. 5 is a plan view of a substrate,

FIG. 6 is a plan view showing a conventional tactile switch;

FIG. 7 is a sectional view taken along a line VII-VII of FIG. 6;

FIG. 8 is a bottom view of the tactile switch;-and

FIG. 9 is a plan view showing a substrate.

### DETAILED DESCRIPTION OF THE PREFERRED EMBODIMENT

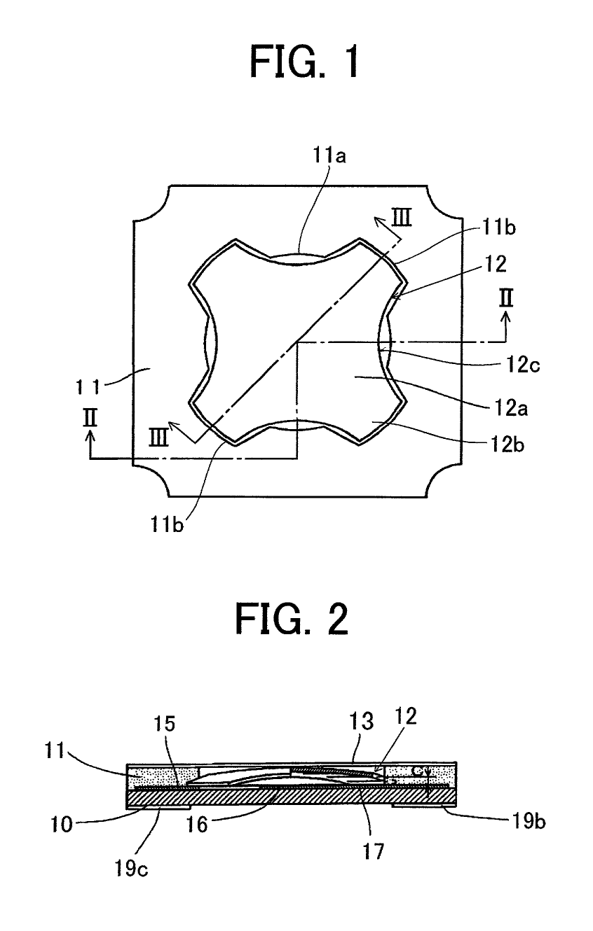

Referring to FIGS. 1 and 2, the tactile switch has a substrate 10, an annular first fixed contact 15 secured to the substrate 10, a second fixed contact 16 provided at a central portion of the substrate 10, a spring contact 12, a flexible cover 13 made of plastic and secured to the substrate 10 through a spacer 11 so as to provide a watertight sealing, and terminal electrodes 19a to 19d at four corners.

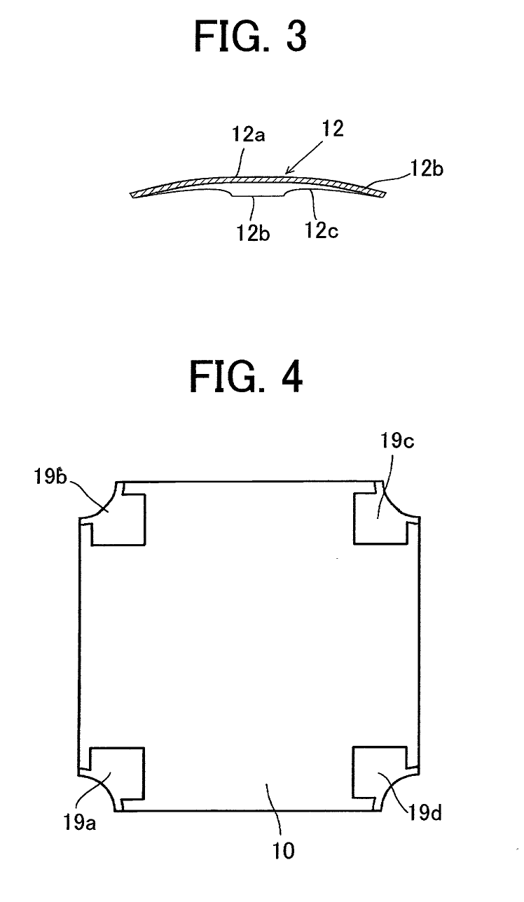

The spring contact 12 has a substantially cross shape in plan view as shown in FIG. 1, and hence comprises a central spherical body 12a and four legs 12b. As shown in FIG. 3, the spherical body 12a and the legs 12b are continuously curved, and an arc portion 12c is formed between the legs 12b. Each of the legs 12b is engaged with the first fixed contact 15 at a peripheral edge thereof.

As shown in FIG. 1, a hole 11a of the spacer 11 has four recesses 11b in which legs 12b of the spring contact 12 are engaged so as to prevent the spring contact from rotating.

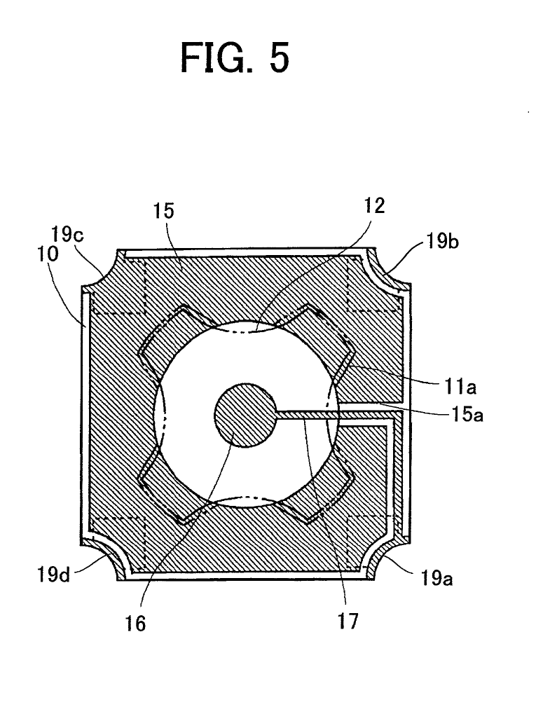

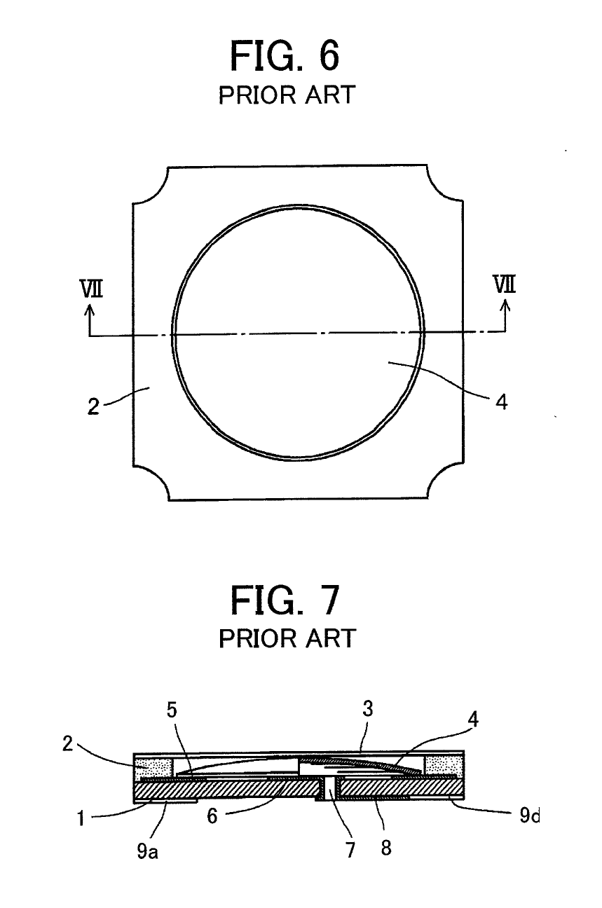

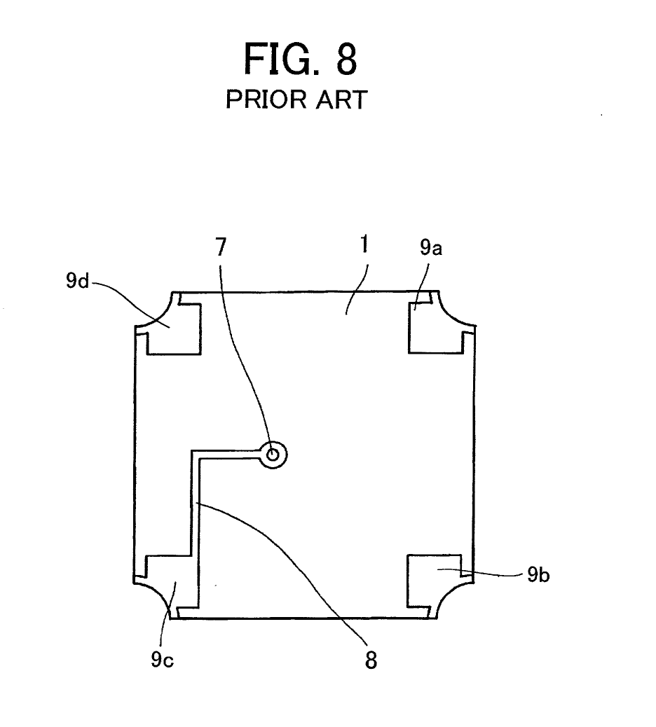

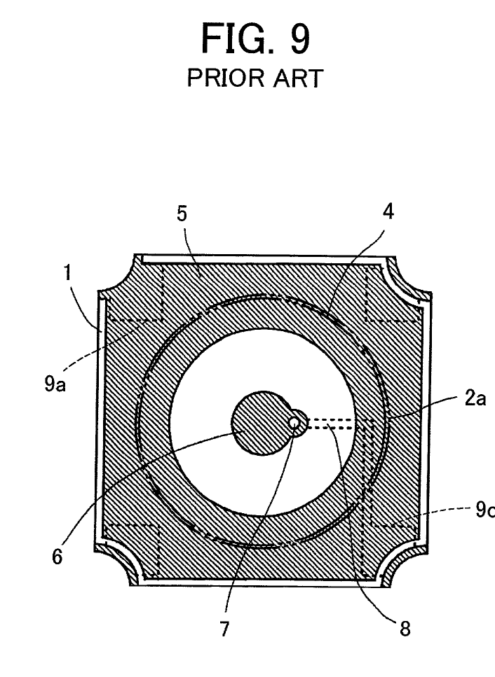

Referring to FIG. 5, the first fixed contact 15 has a passage 15a, and the second fixed contact 16 is connected to the terminal electrode 19a by a conductive pattern 17, passing through the passage 15a and a space c(Fig. 2) under the arc portion 12c. The first fixed contact 15 is connected to the terminal electrode 19c.

When the spring contact 4 of the prior art is depressed at the central portion, the central portion is bent in an inverted spherical shape so that a stress generated at the circular peripheral edge concentrates in the central portion. Consequently, large impact sounds generate.

In the spring contact 12 of the present invention, stresses generated at the legs 12b transmit also to the arc portions 12c, so that concentration of the stress at the central portion reduces. Thus, impact sounds decrease.

Furthermore, in accordance with the present invention, since a through-hole is not provided in the substrate, the construction of the switch becomes simple and manufacturing cost reduces.

While the invention has been described in conjunction with preferred specific embodiment thereof, it will be understood that this description is intended to illustrate and not limit the scope of the invention, which is defined by the following claims.

What is claimed is:

1. A tactile switch comprising:
a substrate;
an annular first fixed contact provided on the substrate;
a second fixed contact provided on the substrate within the first fixed contact;
a spherical spring contact having legs contacted with the first fixed contact.

2. The tactile switch according to claim 1 wherein each of the legs contacts with the first fixed contact at a peripheral edge thereof.

3. The tactile switch according to claim 1 wherein an arc portion is formed between adjacent legs.

4. The tactile switch according to claim 3 wherein the second fixed contact is connected to a terminal electrode by a conductive pattern passing through a passage formed in the first fixed contact and a space formed under the arc portion.
